(19) United States
(12) Patent Application Publication
(10) Pub. No.: US 2007/0040872 A1
(43) Pub. Date: Feb. 22, 2007

(54) Inkjet head

(75) Inventors: Young-Seuck Yoo, Seoul (KR); Sung-Jun Park, Seoul (KR); Young-Jae Kim, Suwon-si (KR); Jae-Woo Joung, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/501,078

(22) Filed: Aug. 9, 2006

(30) Foreign Application Priority Data
Aug. 17, 2005 (KR) 10-2005-0075417

(51) Int. Cl. B41J 2/045

(52) U.S. Cl. 347/70

(57) ABSTRACT

An inkjet head for preventing blockage in the nozzles is disclosed. An inkjet head, in which ink stored in an ink chamber is sprayed through a nozzle, comprising a nozzle part in which the nozzle is formed, a vibration part joined to the nozzle part to be positioned around the nozzle, and an operation part for transferring operating power to the vibration part, allows an application of ultrasonic vibration on the nozzle part of the inkjet head to remove blockage in the nozzles and improve the maintenance and management efficiency of the nozzles.

### CROSS-REFERENCE TO RELATED APPLICATIONS

This application claims the benefit of Korean Patent Application No. 2005-75417 filed with the Korea Industrial Property Office on Aug. 17, 2005, the disclosure of which is incorporated herein by reference in its entirety.

### BACKGROUND

1. Technical Field

The present invention relates to an inkjet head, more specifically to an inkjet head for preventing blockage in the nozzles.

2. Description of the Related Art

The blockage of nozzles in an inkjet head is a major cause of reduced head durability. This often occurs because some of the particles of the ink supplied through an inkjet head nozzle, which is typically perforated in a circular shape, are greater than the size of the nozzle, or because particles having irregular shapes instead of a spherical shape are included.

Also, there is a recent trend of adding metal particles of several μm in the ink, where severe blockage occurs when such particles mass together in the vicinity of the nozzle.

Generally, there are several hundreds of nozzles in an inkjet head, and as a blockage in just one of the plurality of nozzles may lead to a malfunctioning of the entire head, the art of preventing blockage in nozzles is essential to the management and maintenance of an inkjet head.

FIGS. 1 and 2 are schematic diagrams illustrating a suction process and an ultrasonic cleansing process for preventing blockage in the nozzles of an inkjet head according to previous art. Examples of conventional methods for preventing blockage in the nozzles of an inkjet head include the method shown in FIG. 1, of attaching a suction device 3 to the nozzle part 10 and supplying a negative pressure to forcefully suck in and remove ink particles 1 blocking the nozzle 12, and the method shown in FIG. 2, of depositing the nozzle part 10 of the inkjet head in an ultrasonic cleansing device 7 and afterwards applying ultrasonic vibration to separate and remove ink particles 1 blocking the nozzles 12. Other examples include methods of wiping the surface of the nozzles or of applying a cap, etc.

However, such prior methods are follow-up measures in that the ink particles are removed after blockage of the nozzle has already occurred, and since the ink head must be separated when removing ink particles blocking the nozzle, printing is inevitably discontinued. Also, an additional device must be used to resolve nozzle blockage, such as a suction device, ultrasonic cleansing device, wiper, or cap, etc., and the bigger the ink particles blocking the nozzle, a reason for which may be prolonged disuse of the inkjet head, the lower the efficiency in removing the particles.

Meanwhile, prior art also includes cases in which a piezoelectric element is applied to the inkjet head, where the piezoelectric element generates vibration when electric power is supplied. Examples of such may include, first, an invention using piezoelectric elements and jet pins connected thereto in the inkjet head, so that when electric power is not supplied, the nozzle cylinders are sealed, and blockage in the nozzles is prevented due to the drying of the ink. This, however, is a technique of preventing blockage in the nozzles, and cannot remove ink that is already blocking the nozzles.

A second example may include an invention in which a signal generator and controller are added which generate an electric power pulse greater than the power pulse necessary for ink ejection on the piezoelectric elements to remove ink blockage. This, however, is a technique of utilizing the piezoelectric elements originally for ink ejection in preventing nozzle blockage, and there are no components added that are exclusively for preventing nozzle blockage.

### SUMMARY

The present invention aims to provide an inkjet head for preventing blockage in the nozzles, which allows an application of ultrasonic vibration on the nozzle part of the inkjet head to remove blockage in the nozzles and improve the maintenance and management efficiency of the nozzles.

One aspect of the present invention provides an inkjet head, in which ink stored in an ink chamber is sprayed through a nozzle, comprising a nozzle part in which the nozzle is formed, a vibration part joined to the nozzle part to be positioned around the nozzle, and an operation part for transferring operating power to the vibration part.

The vibration part may preferably receive the operating power and generate vibration of a frequency corresponding to an ultrasonic wave. Preferably, the vibration part may comprise a piezoelectric element, and the operation part may be electrically connected to a power source.

The piezoelectric element may comprise a PZT piezoelectric element. The operation part may comprise electrical wiring that is electrically connected with the piezoelectric element. The vibration part may be positioned radially around the nozzle. The vibration part may have a donut-shaped configuration.

The vibration part may preferably be fastened to the nozzle part to move as a single structural body. The vibration part may be detachably joined to the nozzle part.

Another aspect of the present invention provides an inkjet printing device comprising an inkjet head comprising a nozzle part having a nozzle formed therein, a vibration part joined to the nozzle part to be positioned around the nozzle, and an operation part for transferring operating power to the vibration part; a first control part for transmitting a signal to the operation part; a second control part for controlling the operation of the inkjet head; and a power source part for supplying power to the first control part and the second control part.

The vibration part may comprise a piezoelectric element, and the operation part may comprise electrical wiring electrically connected with the piezoelectric element. The first control part and the second control part may be formed as a single body. The first control part may transmit signals in correspondence with predetermined time intervals. The first control part may transmit signals in correspondence with outside input.

Additional aspects and advantages of the present invention will be set forth in part in the description which follows and, in part, will be apparent from the description, or may be learned by practice of the invention.

### BRIEF DESCRIPTION OF THE DRAWINGS

FIG. 1 is a schematic diagram illustrating a suction process for preventing blockage in the nozzles of an inkjet head according to previous art.

FIG. 2 is a schematic diagram illustrating an ultrasonic cleansing process for preventing blockage in the nozzles of an inkjet head according to previous art.

FIG. 3 is a plan view of the nozzles of an inkjet head according to an embodiment of the present invention.

FIG. 4 is a cross-sectional view across A-A′ of FIG. 3.

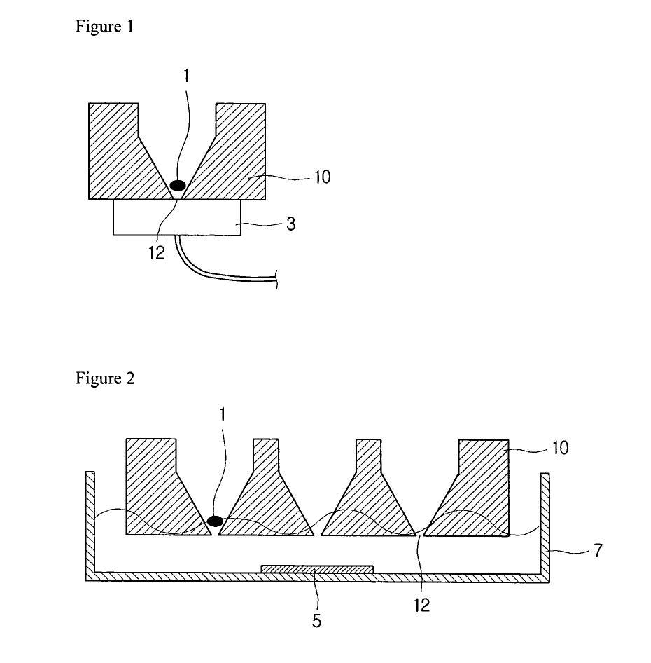

### DETAILED DESCRIPTION

Embodiments of the present invention will now be described in more detail with reference to the accompanying drawings, wherein like reference numerals refer to the like elements throughout, and redundant explanations are omitted.

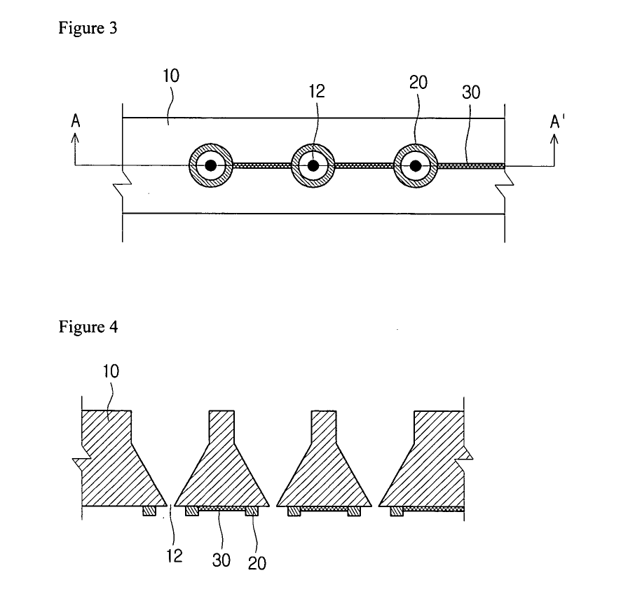

FIG. 3 is a plan view of the nozzles of an inkjet head according to an embodiment of the present invention, and FIG. 4 is a cross-sectional view across A-A′ of FIG. 3. In FIGS. 3 and 4 are illustrated a nozzle part 10, nozzles 12, piezoelectric elements 20, and an operation part 30.

Unlike conventional methods in which separate devices are used to remove ink particles blocking a nozzle 12 of an inkjet head, a vibration part is attached directly on the nozzle part 10 of the inkjet head to generate ultrasonic vibration on the nozzle part 10. Thus, ink particles may be removed even during printing, and the efficiency may be increased of removing ink particles using conventional methods.

That is, an inkjet head according to the present embodiment is such that allows ink stored in an ink chamber to be sprayed through the nozzles 12, and has the key components of a nozzle part 10, a vibration part joined to the nozzle part 10, and an operation part 30 which transfers operating power to the vibration part.

The nozzle part 10 is the portion where the nozzles 12 are formed, through which ink is sprayed, and refers to a portion of the inkjet head, rather than to a particular component. Thus, the material of which the nozzle part 10 is made is typically the same as the material of the inkjet head.

Meanwhile, a hydrophobic layer is generally formed around a nozzle 12 of an inkjet head to allow the menisci of the ink droplets to be formed adequately, and the nozzle part 10 of the present invention includes all of the surrounding structure of the nozzles 12 such as the hydrophobic layer described above.

The vibration part is a component which receives electrical power to generate vibration, for which piezoelectric elements 20 are used in the present embodiment. A piezoelectric element 20 is an element which induces conversion between vibration energy and electrical energy by generating a voltage when mechanical pressure is applied or by creating a mechanical deformation when electrical power is supplied. As the piezoelectric element 20 is a component well known to those skilled in the art, detailed explanations regarding its principles or its specific composition will not be provided.

A PZT piezoelectric element is preferable for the piezoelectric element 20 of the present embodiment. A PZT piezoelectric element contains PbO, ZrO₂, and TiO₂, and is commonly used due to its low cost, and does not present a problem in its application to the present invention for providing vibration on the inkjet head. However, the piezoelectric element 20 of the present invention is not necessarily limited to a PZT piezoelectric element, and it is to be appreciated that other types of piezoelectric element may also be used within a range apparent to those skilled in the art.

In order for the vibration generated by the piezoelectric elements 20 to be transferred to the nozzle part 10 to separate the ink particles blocking a nozzle 12, the piezoelectric elements 20 may advantageously be joined so that they are positioned around the nozzle 12. That is, the closer the joining position of a piezoelectric element 20 is to the nozzle 12, the higher is the efficiency of vibration transfer and the more improved is the consequent effect of removing the ink particles.

However, since the nozzle 12 is a hole through which ink is sprayed, the ink sprayed through the nozzle 12 may splatter onto a piezoelectric element 20 if the piezoelectric element 20 is joined too close to the nozzle 12, causing a reduction in printing quality. Therefore, the piezoelectric element 20 may advantageously be joined close to the nozzle 12 while keeping a distance such that ink sprayed through the nozzle 12 is not splattered onto it.

Also, in order for the vibration generated by the piezoelectric elements 20 to be transferred effectively to the nozzle 12, the piezoelectric elements 20 are positioned radially around the nozzle 12. In other words, the vibration is transferred to the nozzle 12 not from one particular direction, but from all directions centered around the nozzle 12, to effectively remove ink particles blocking the nozzle 12.

When positioning spot type piezoelectric elements 20, the piezoelectric elements 20 may be attached to form a radial configuration centered around the nozzle 12, and when positioning line type piezoelectric elements 20, the piezoelectric elements 20 may be attached to surround the nozzle 12.

Thus, the piezoelectric elements 20 are attached around the nozzles 12 in a donut-shaped configuration, as illustrated in FIG. 3. However, the configuration of the piezoelectric elements 20 of the present invention is not necessarily limited to the shape of a donut, and it is apparent to those skilled in the art that the piezoelectric elements 20 may also be attached in other configurations such that allow positioning around the nozzle 12 to effectively transfer vibration to the nozzle part 10.

The vibration part, such as the piezoelectric elements 20, etc., according to the present invention may advantageously generate vibration of a frequency corresponding to an ultrasonic wave. An ultrasonic wave refers to a sound wave having a frequency exceeding the audible frequency range, of approximately 20,000 Hz or more, and conventional methods have also generated and used vibration in an ultrasonic range for removing ink particles due to its advantages in terms of noise and vibration efficiency.

However, the present invention is not limited to a particular range of frequencies for the vibration generated by the vibration part, and it is apparent to those skilled in the art that frequencies of other ranges may also be used such that allow the transfer of vibration to the nozzle 12 of the inkjet head to remove ink particles.

In order for the vibration generated by the piezoelectric elements 20 to be transferred to the nozzle part 10 of the inkjet head so that the nozzle part 10 vibrates together with the piezoelectric elements 20, the piezoelectric elements 20 must be fastened to the nozzle part 10 to move as a single structural body. To this end, a joining means such as screws, adhesive, etc., are used to join the piezoelectric elements 20 to the surface of the nozzle part 10. If the piezoelectric elements 20 are not joined as a single structural body with the nozzle part 10, the vibration generated at the piezoelectric elements 20 may not be transferred to the nozzle part 10 at all, or may be transferred in a distorted manner to lower the efficiency of removing blockage in the nozzle 12.

Also, as the piezoelectric elements 20 are components added to the nozzle part 10 of the inkjet head, they are typically attached onto the surface of the nozzle part 10, but the present invention is not necessarily thus limited, and it is to be appreciated that the piezoelectric elements 20 may also be joined within the structure of the inkjet head, such as by embedding the piezoelectric elements 20 within the nozzle part 10 during the manufacturing process of the inkjet head.

However, when the piezoelectric elements 20 are attached onto the surface of the nozzle part 10, they also act as craters around the nozzles 12, as illustrated in FIG. 4, and consequently the nozzle face is protected by the piezoelectric elements 20. To thus obtain the effect of protecting the nozzle face with the piezoelectric elements 20, it is preferable to attach the piezoelectric elements 20 onto the surface of the nozzle face.

Meanwhile, since the piezoelectric elements 20 are components for removing blockage in the nozzle 12 and are unrelated to the printing by the inkjet head, they may be joined detachably to the nozzle part 10 so that they may be used only when needed. When making the piezoelectric elements 20 detachable with respect to the nozzle part 10, they must be joined by a joining method that allows structurally integrated movement, so that when joined, the vibration generated at the piezoelectric elements 20 are effectively transferred to the nozzle part 10. The joining method which allows structurally integrated movement is well known to those skilled in the art, and thus detailed explanations on this matter are not provided.

Since the piezoelectric elements 20 receive electrical energy and convert it into vibration energy, in addition to attaching the piezoelectric elements 20 around the nozzle 12, it is necessary to further join the operation part 30, which transfers operating power such as electrical power, etc., to the piezoelectric elements 20. In the case of typical piezoelectric elements 20, which receive electrical power to generate vibration, the operation part 30 is a connection means, such as electrical wiring, that implements an electrical connection with the power source. However, the operation part 30 of the present invention for supplying electrical power to the piezoelectric elements 20 is not necessarily limited to electrical wiring, and it is to be appreciated that other electrical connection means may also be included within a range apparent to those skilled in the art.

As shown in FIGS. 3 and 4, when the piezoelectric elements 20 are attached onto the surface of the nozzle part 10 of the inkjet head, the operation part 30 is also attached together. In this case, it will be advantageous to appropriately adjust the positions of the electrodes of the piezoelectric elements 20, so that the operation part 30 is joined in a way such that the plurality of piezoelectric elements 20 are connected to the power source through the shortest path, as in FIG. 3.

In order to generate vibration in the nozzle part 10 by supplying power to the piezoelectric elements 20 and remove ink particles blocking the nozzle 12, a control part is installed, which controls the power supply to the piezoelectric elements 20, in an inkjet printing device using an inkjet head based on the present invention.

That is, in an inkjet printing device based on the present invention using an inkjet head comprising a nozzle part 10, piezoelectric elements 20 joined to the nozzle part 10, and an operation part 30 for transferring operating power to the piezoelectric elements 20, a separate control part is comprised for controlling the electrical power transferred to the piezoelectric elements 20, in addition to a control part for controlling the operation of the overall devices such as the inkjet head, etc. Each of the control parts is supplied with electrical power from a power source part.

When piezoelectric elements 20 are used for the vibration part of the present invention, the operation part 30 which supplies power to the piezoelectric elements 20 is electrically connected with the controller installed in the inkjet printing device. While the controller connected with the operation part 30 is a separate control part controlling only the operation of the piezoelectric elements 20, the control part controlling the operation of the piezoelectric elements 20 may be integrated with the control part controlling the overall inkjet printing device to form a single body and act as a single control part.

In this case, the power supplied to the piezoelectric elements 20 joined to the nozzle part 10 may be controlled by forming terminals, etc., for connecting to the operation part 30 on the control part for controlling the overall inkjet printing device, and by forming a circuit on the operation part 30 for transferring signals. However, the present invention is not limited to the composition set forth above with regards the operation part 30 for transferring operating power to the piezoelectric elements 20 joined to the nozzle part 10 and the electrical connection between controllers of the inkjet printing device, and it is to be appreciated that other compositions may also be used within a range apparent to those skilled in the art, such as that in which the operation part 30 is connected to the control part of the printing device via a direct connection to the electrical connection part of the inkjet head, etc.

When controlling the power supply to the piezoelectric elements 20 by means of the control part of the inkjet printing device, the control part is made to generate control signals in certain time intervals. Thus, ultrasonic vibration is transferred to the nozzle part 10 at certain times while printing is or is not in process, to prevent the possible occurrence of blockage in the nozzles 12.

Also, the control part is made to generate control signals in response to outside input. This allows a user to transfer an input signal to the control part by means of an input button, etc., while using the printing device, when blockage of the nozzles 12 has actually occurred or is likely to occur, in order to remove or prevent the blockage of the nozzles 12.

According to the present invention comprised as above, by attaching piezoelectric elements around the nozzles and allowing an application of ultrasonic vibration on the nozzle part of an inkjet head, nozzle blockage may be removed and the maintenance and management efficiency of the inkjet head may be improved.

Also, as the inkjet head does not have to be separated to remove ink particles blocking the nozzles, such measures may be taken to prevent nozzle blockage even during printing. Further, since vibration may be applied to the nozzle part of the inkjet head even while removing blockage in the nozzles using conventional methods such as suction and ultrasonic cleansing, etc., the efficiency of nozzle blockage removal is improved.

While the spirit of the invention has been described in detail with reference to particular embodiments, the embodiments are for illustrative purposes only and do not limit the invention. It is to be appreciated that various embodiments may be implemented without departing from the principles and spirit of the invention.

What is claimed is:

1. An inkjet head wherein ink stored in an ink chamber is sprayed through a nozzle, the inkjet head comprising:
a nozzle part having the nozzle formed therein;
a vibration part joined to the nozzle part to be positioned around the nozzle; and
an operation part for transferring operating power to the vibration part.

2. The inkjet head of claim 1, wherein the vibration part receives the operating power to generate vibration of a frequency corresponding to an ultrasonic wave.

3. The inkjet head of claim 1, wherein the vibration part comprises a piezoelectric element, and the operation part is electrically connected to a power source.

4. The inkjet head of claim 3, wherein the piezoelectric element comprises a PZT piezoelectric element.

5. The inkjet head of claim 3, wherein the operation part comprises electrical wiring electrically connected with the piezoelectric element.

6. The inkjet head of claim 1, wherein the vibration part is positioned radially around the nozzle.

7. The inkjet head of claim 1, wherein the vibration part has a donut-shaped configuration.

8. The inkjet head of claim 1, wherein the vibration part is fastened to the nozzle part to move as a single structural body.

9. The inkjet head of claim 1, wherein the vibration part is detachably joined to the nozzle part.

10. An inkjet printing device comprising:
an inkjet head comprising a nozzle part having a nozzle formed therein, a vibration part joined to the nozzle part to be positioned around the nozzle, and an operation part for transferring operating power to the vibration part;
a first control part for transmitting a signal to the operation part;
a second control part for controlling the operation of the inkjet head; and
a power source part for supplying power to the first control part and the second control part.

11. The inkjet printing device of claim 10, wherein the vibration part comprises a piezoelectric element, and the operation part comprises electrical wiring electrically connected with the piezoelectric element.

12. The inkjet printing device of claim 10, wherein the first control part and the second control part are formed as a single body.

13. The inkjet printing device of claim 10, wherein the first control part transmits signals in correspondence with predetermined time intervals.

14. The inkjet printing device of claim 10, wherein the first control part transmits signals in correspondence with outside input.
